(19) United States
(12) Patent Application Publication
(10) Pub. No.: US 2009/0232318 A1
(43) Pub. Date: Sep. 17, 2009

(54) OUTPUT CORRECTING DEVICE AND METHOD, AND LOUDSPEAKER OUTPUT CORRECTING DEVICE AND METHOD

(75) Inventor: Yoshiki Ohta, Saitama (JP)

Correspondence Address: YOUNG & THOMPSON, 209 Madison Street, Suite 500, ALEXANDRIA, VA, 22314, US

(73) Assignee: PIONEER CORPORATION, TOKYO (JP)

(21) Appl. No.: 12/306,542

(22) PCT Filed: Jun. 3, 2007
(86) PCT No.: PCT/JP2007/063285

§ 371 Date: Dec. 24, 2008

(30) Foreign Application Priority Data
Jul. 3, 2006 (JP) 2006-183441

(51) Int. Cl. H04B 15/00; H04R 29/00

(52) U.S. Cl. 381/56; 381/94.1

(57) ABSTRACT

A loudspeaker output correcting device operable under control of a control element, and comprising a first loudspeaker for outputting a first test signal, a second loudspeaker for outputting a second sound signal including a second test signal such that the phase of the second test signal is almost the same as that of the first one and when the second test signal is combined with the first one, the power characteristic is a constant value, sound collecting element for collecting the outputted first and second test signals, computing element for computing the difference between the first distance between the first loudspeaker and the sound collecting element and the second distance; between the second loudspeaker and the sound collecting element from the spectrum of the combined signal produced by combining the collected first and second signals, and correcting element for correcting the output relative characteristics of the first and second loudspeakers.

### TECHNICAL FIELD

The present invention relates to an output correcting apparatus for and method of correcting the output of a speaker apparatus, which is provided with two speakers, and a speaker output correcting apparatus and method, for example.

### BACKGROUND ART

For example, a patent document 1 or the like discloses a method of estimating a distance difference between two speakers that are not disposed at equal distances from an audience, for example. That is, in this estimation method, the same test signal is outputted simultaneously from the two speakers and sound-collected or sound-obtained by a sound collecting device such as a microphone, and on the basis of autocorrelation of the sound-collected signal, the distance difference of the two speakers is estimated.
Patent document 1: Japanese Patent Application Laid Open NO. 2004-166106

### DISCLOSURE OF INVENTION

### Subject to be Solved by the Invention

According to the aforementioned patent document 1, however, it is necessary to output the test signal a plurality of times such as three times. Thus, there is such a technical problem that a processing procedure for estimating the distance difference between the two speakers becomes redundant and complicated.

In view of the aforementioned problems, it is therefore an object of the present invention to provide an output correcting apparatus and method, which can calculate the distance difference between the two speakers simply and quickly and which can appropriately perform an output correction on the speakers on the basis of the calculated distance difference, and a speaker output correction apparatus and method, for example.

### Means for Solving the Subject

### (Output Correcting Apparatus)

The above object of the present invention can be achieved by an output correcting apparatus provided with: a first output terminal connected to a first speaker for outputting a first test signal; a second output terminal connected to a second speaker for outputting a second test signal which has substantially a same phase as the first test signal and in which a power feature (e.g. square sum of amplitude) has a constant value if the second test signal is synthesized with the first test signal; a calculating device for calculating a difference between a first distance and a second distance, on the basis of a spectrum of a synthesized signal obtained by synthesizing the outputted first test signal and second test signal, the first distance being a distance between the first speaker and a sound-collecting device for sound-collecting the first test signal and the second test signal, the second distance being a distance between the second speaker and the sound-collecting device; a correcting device for correcting a relative output feature (a delay amount and an output level coefficient) in the first speaker and the second speaker; and a controlling device for controlling the correcting device to correct the output feature on the basis of the calculated difference.

According to the output correcting apparatus of the present invention, the first test signal is outputted by the first speaker connected to the first output terminal. The second test signal, which has substantially the same phase as the first test signal and in which the power feature (e.g. square sum of amplitude) has a constant value if the second test signal is synthesized with the first test signal, is outputted by the second speaker connected to the second output terminal. Here, the “power feature” of the present invention denotes a feature in the power level of two signals such as a sum of the square of the amplitude of the first test signal and the square of the amplitude of the second test signal. The outputted first test signal and second test signal are sound-collected by the sound-collecting device. The difference between (i) the first distance, which is the distance between. the first speaker and the sound-collecting device, and (ii) the second distance, which is the distance between the second speaker and the sound-collecting device, is calculated by the calculating device on the basis of the spectrum of the synthesized signal obtained by synthesizing the sound-collected first test signal and second test signal. The relative output feature in the first speaker and the second speaker is corrected by the correcting device. Here, the “output feature” of the present invention denotes a predetermined feature for relatively changing an output time and timing or an output level, such as a delay amount and a correction coefficient of an output level, in the two speakers. Under the control of the controlling device, the output feature is corrected by the correcting device on the basis of the calculated difference.

In particular, according to the present invention, as described above, the phases of the first test signal and the second test signal are substantially equal, and the power feature of the first test signal and the second test signal is substantially constant. Therefore, if the first distance, which is the distance between the first speaker and the sound-collecting device, is substantially equal to the second distance, which is the distance between the second speaker and the sound-collecting device, the power feature of the synthesized signal obtained by synthesizing the first test signal and the second test signal at each frequency has a substantially constant value.

Thus, it can be concluded that if there is generated a frequency band in which the power feature is at a relatively low level (or a power-lacked frequency band), a phase difference which causes the low-level power feature is almost or totally due to the difference between a procedure in which a sound corresponding to the first test signal travels in the air and a procedure in which a sound corresponding to the second test signal travels in the air. In other words, it can be concluded that the phase difference which causes the low-level power feature corresponds to the difference between the first distance, which is for the first test signal to arrive at the sound-colleting device from the speaker, and the second distance, which is for the second test signal to arrive at the sound-colleting device from the speaker. In particular, if the phase difference between the first test signal and the second test signal is equal to half of a predetermined wavelength, the power feature is substantially zero, and the magnitude of the power lack amount is maximal. Specifically, the phase difference calculated on the basis of the frequency at which the power feature is at the relatively low level corresponds to the difference between (i) the first distance, which is for the first test signal to arrive at e.g. the sound-collecting device from the first speaker, and (ii) the second distance, which is for the second test signal to arrive at e.g. the sound-collecting device from the second speaker. Therefore, the difference between the first distance and the second distance can be calculated on the basis of the frequency at which the power feature is at the relatively low level, and a sound velocity. On the basis of the calculated difference, the output feature is appropriately corrected by the correcting device, under the control of the controlling device.

Consequently, according to the present invention, it is possible to simply and quickly calculate the distance difference (i.e. difference) between the two speakers, for example, and it is possible to appropriately and quickly perform the speaker output correction, on the basis of the calculated distance difference (i.e. difference).

In one aspect of the output correcting apparatus of the present invention, the calculating device calculates the difference on the basis of (i) a frequency at which the power feature is at a minimum level, in a portion in which the first test signal and the second test signal overlap, included in the spectrum.

According to this aspect, as a first stage, the difference is calculated by the calculating device, on the basis of (i) the frequency at which the power feature is at the minimum level, in the portion in which the first test signal and the second test signal overlap, included in the spectrum.

As a result, it is possible to calculate the feature value of the output feature such as a delay amount, highly accurately, on the basis of the calculated difference, and it is possible to perform the output correction of the speaker, more appropriately and highly accurately, on the basis of the calculated feature value of the output feature.

In an aspect associated with the calculating device described above, the calculating device may include a determining device for determining a magnitude relation between the first distance and the second distance, on the basis of (ii) a spectrum shape in a portion in which the first test signal and the second test signal do not overlap, included in the spectrum, corresponding to the calculated difference.

By virtue of such construction, as a second stage, the magnitude relation between the first distance and the second distance is determined by the determining device included in the calculating device, on the basis of (ii) the spectrum shape in the portion in which the first test signal and the second test signal do not overlap, included in the spectrum, corresponding to the calculated difference.

As a result, on the basis of the calculated difference, the feature value of the output feature such as a delay amount can be applied to the first speaker or the second speaker, highly accurately.

In an aspect associated with the calculating device described above, the calculating device may calculate a delay amount for relatively delaying an output time in the first output terminal or the second output terminal, on the basis of the spectrum shape in the portion in which the first test signal and the second test signal do not overlap.

By virtue of such construction, as a third stage, the delay amount for relatively delaying the output time in the first output terminal or the second output terminal is calculated by the calculating device on the basis of the (ii) the spectrum shape in the portion in which the first test signal and the second test signal do not overlap, included in the spectrum corresponding to the calculated difference.

As a result, it is possible to calculate the feature value of the output feature such as the delay amount, highly accurately on the basis of the calculated difference, and it is possible to perform the output correction of the outputting device more appropriately and highly accurately, on the basis of the calculated feature value of the output feature.

In another aspect of the output correcting apparatus of the present invention, the controlling device further controls the first output terminal and the second output terminal to output the first test signal and the second test signal simultaneously in terms of time.

According to this aspect, the calculating device can calculate the difference, highly accurately, on the basis of the spectrum of the synthesized signal obtained by synthesizing the first test signal and the second test signal, which are simultaneously outputted in terms of time and which are sound-collected.

In another aspect of the output correcting apparatus of the present invention, the correcting device corrects (i) a delay amount for relatively delaying an output time in the first output terminal and the second output terminal and (ii) a coefficient for relatively changing an output level in the first output terminal and the second output terminal, as the output feature.

According to this aspect, it is possible to perform the output correction of the outputting device, more appropriately and highly accurately, on the basis of the delay amount and the coefficient.

In another aspect of the output correcting apparatus of the present invention, the calculating device calculates the difference on the basis of a Fourier transform spectrum of the synthesized signal.

According to this aspect, the calculating device can calculate the difference, highly accurately, on the basis of the so-called Fourier transform spectrum of the synthesized signal, which is obtained by Fourier-transforming the synthesized signal.

In another aspect of the output correcting apparatus of the present invention, a frequency band in the first test signal and the second test signal is determined, in accordance with an accuracy of a delay amount for relatively delaying an output time in the first output terminal and the second output terminal, on the correcting device.

According to this aspect, it is possible to perform the output correction of the outputting device, more appropriately and highly accurately, on the basis of the first test signal and the second test signal, which have frequencies included in the frequency band determined in accordance with the accuracy of the delay amount.

In another aspect of the output correcting apparatus of the present invention, a frequency band in the first test signal and the second test signal is defined to be low, if a delay amount for relatively delaying an output time in the first output terminal and the second output terminal increases.

According to this aspect, the frequencies of the first test signal and the second test signal are included in the frequency band which is defined to be low as the delay amount increases. Therefore, it is possible to perform the output correction of the outputting device, more appropriately and highly accurately, on the basis of the frequency which is defined to be low as the delay amount increases.

In another aspect of the output correcting apparatus of the present invention, a frequency band in the first test signal and the second test signal is different from a frequency band of a noise sound in an external world.

According to this aspect, it is possible to perform the output correction of the outputting device, more appropriately and highly accurately, on the basis of the first test signal and the second test signal, which have frequencies included in the different frequency band from the frequency band of the noise sound in the external world.

In another aspect of the output correcting apparatus of the present invention, the calculating device calculates the difference, on the basis of a portion sound-collected in a relatively early time, of a portion in which the first test signal and the second test signal overlap, included in the spectrum.

According to this aspect, the calculating device calculates the difference, on the basis of the portion sound-collected in the relatively early time, of the portion in which the first test signal and the second test signal directly overlap, included in the spectrum. Therefore, the calculating device can calculate the difference, highly accurately, while reducing an influence by the external world such as echo in an acoustic space.

In another aspect of the output correcting apparatus of the present invention, the calculating device calculates the difference, on the basis of a portion immediately, after a portion in which the first test signal and the second test signal overlap, arrives at the sound-collecting device, included in the spectrum.

According to this aspect, it is possible to calculate the frequency at which the power feature is at the minimum level in the spectrum, and therefore the aforementioned difference, highly accurately, with little or no influence by the external world such as echo in an acoustic space, on the basis of the portion immediately after such a portion that the first test signal and the second test signal overlap, arrives at the sound-collecting device, included in the spectrum.

### (Speaker Output Correcting Apparatus)

The above object of the present invention can be also achieved by a speaker output correcting apparatus provided with: a first speaker for outputting a first audio signal including a first test signal; a second speaker for outputting a second audio signal including a second test signal which has substantially a same phase as the first test signal and in which a power feature (e.g. square sum of amplitude) has a constant value if the second test signal is synthesized with the first test signal; a sound-collecting device for sound-collecting the outputted first test signal and second test signal; a calculating device for calculating a difference between a first distance and a second distance, on the basis of a spectrum of a synthesized signal obtained by synthesizing the sound-collected first test signal and second test signal, the first distance being a distance between the first speaker and the sound-collecting device, the second distance being a distance between the second speaker and the sound-collecting device; a correcting device for correcting a relative output feature (a delay amount and an output level coefficient) in the first speaker and the second speaker; and a controlling device for controlling the correcting device to correct the output feature on the basis of the calculated difference.

According to the speaker output correcting apparatus of the present invention, the first audio signal including the first test signal is outputted by the first speaker. The second audio signal including the second test signal, which has substantially the same phase as the first test signal and in which the power feature (e.g. square sum of amplitude) has a constant value if the second test signal is synthesized with the first test signal, is outputted by the second speaker. The outputted first test signal and second test signal are sound-collected by the sound-collecting device. The difference between (i) the first distance, which is the distance between the first speaker and the sound-collecting device, and (ii) the second distance, which is the distance between the second speaker and the sound-collecting device, is calculated by the calculating device on the basis of the spectrum of the synthesized signal obtained by synthesizing the sound-collected first test signal and second test signal. The relative output feature in the first speaker and the second speaker is corrected by the correcting device. Under the control of the correcting device, the output feature is corrected by the correcting device on the basis of the calculated difference.

In particular, according to the present invention, as described above, the phases of the first test signal and the second test signal are substantially equal, and the power feature of the first test signal and the second test signal is substantially constant. Therefore, if the first distance, which is the distance between the first speaker and the sound-collecting device, is substantially equal to the second distance, which is the distance between the second speaker and the sound-collecting device, the power feature of the synthesized signal obtained by synthesizing the first test signal and the second test signal at each frequency has a substantially constant value.

Thus, it can be concluded that if there is generated a frequency band in which the power feature is at a relatively low level (or a power-lacked frequency band), a phase difference which causes the low-level power feature is almost or totally due to the difference between a procedure in which a sound corresponding to the first test signal travels in the air and a procedure in which a sound corresponding to the second test signal travels in the air. In other words, it can be concluded that the phase difference which causes the low-level power feature corresponds to the difference between the first distance, which is for the first test signal to arrive at the sound-colleting device from the speaker, and the second distance, which is for the second test signal to arrive at the sound-colleting device from the speaker. In particular, if the phase difference between the first test signal and the second test signal is equal to half of a predetermined wavelength, the power feature is substantially zero, and the magnitude of the power lack amount is maximal. Specifically, the phase difference calculated on the basis of the frequency at which the power feature is at the relatively low level corresponds to the difference between the first distance, which is for the first test signal to arrive at e.g. the sound-collecting device from the first speaker, and the second distance, which is for the second test signal to arrive at e.g. the sound-collecting device from the second speaker. Therefore, the difference between the first distance and the second distance can be calculated on the basis of the frequency at which the power feature is at the relatively low level, and a sound velocity. On the basis of the calculated difference, the output feature is appropriately corrected by the correcting device, under the control of the controlling device.

Consequently, according to the present invention, it is possible to simply and quickly calculate the distance difference (i.e. difference) between the two speakers, for example, and it is possible to appropriately and quickly perform the speaker output correction, on the basis of the calculated distance difference (i.e. difference).

### (Output Correcting Method)

The above object of the present invention can be also achieved by an output correcting method on an output correcting apparatus provided with: a first output terminal connected to a first speaker for outputting a first test signal; and a second output terminal connected to a second speaker for outputting a second test signal which has substantially a same phase as the first test signal and in which a power feature (e.g. square sum of amplitude) has a constant value if the second test signal is synthesized with the first test signal, the output correcting method provided with: a calculating process of calculating a difference between a first distance and a second distance, on the basis of a spectrum of a synthesized signal obtained by synthesizing the outputted first test signal and second test signal, the first distance being a distance between the first speaker and a sound-collecting device for sound-collecting the first test signal and the second test signal, the second distance being a distance between the second speaker and the sound-collecting device; a correcting process of correcting a relative output feature (a delay amount and an output level coefficient) in the first speaker and the second speaker; and a controlling process of controlling the correcting process to correct the output feature on the basis of the calculated difference.

According to the output correcting method of the present invention, it is possible to receive the various benefits of the output correcting apparatus of the present invention described above.

Incidentally, in response to the various aspects of the aforementioned output correcting apparatus of the present invention, the output correcting method of the present invention can also employ various aspects.

### (Speaker Output Correcting Method)

The above object of the present invention can be also achieved by a speaker output correcting method on a speaker output correcting apparatus provided with: a first speaker for outputting a first audio signal including a first test signal; a second speaker for outputting a second audio signal including a second test signal which has substantially a same phase as the first test signal and in which a power feature (e.g. square sum of amplitude) has a constant value if the second test signal is synthesized with the first test signal; and a sound-collecting device for sound-collecting the outputted first test signal and second test signal, the speaker output correcting method provided with: a calculating process of calculating a difference between a first distance and a second distance, on the basis of a spectrum of a synthesized signal obtained by synthesizing the sound-collected first test signal and second test signal, the first distance being a distance between the first speaker and the sound-collecting device, the second distance being a distance between the second speaker and the sound-collecting device; a correcting process of correcting a relative output feature (a delay amount and an output level coefficient) in the first speaker and the second speaker; and a controlling process of controlling the correcting device to correct the output feature on the basis of the calculated difference.

According to the speaker output correcting method of the present invention, it is possible to receive the various benefits of the speaker output correcting apparatus of the present invention described above.

Incidentally, in response to the various aspects of the aforementioned speaker output correcting apparatus of the present invention, the speaker output correcting method of the present invention can also employ various aspects.

The operation and other advantages of the present invention will become more apparent from the embodiments explained below.

As explained above, according to the output correcting apparatus and method of the present invention, it is provided with the first output terminal connected to the first speaker, the second output terminal connected to the second speaker, the calculating device, the correcting device, and the controlling device. Consequently it is possible to simply and quickly calculate the distance difference (i.e. difference) between the two speakers, for example, and it is possible to appropriately and quickly perform the speaker output correction, on the basis of the calculated distance difference (i.e. difference).

Moreover, according to the speaker output correcting apparatus and method of the present invention, it is provided with the first speaker, the second speaker, the sound-collecting device, the calculating device, the correcting device, and the controlling device. Consequently, it is possible to simply and quickly calculate the distance difference (i.e. difference) between the two speakers, for example, and it is possible to appropriately and quickly perform the speaker output correction, on the basis of the calculated distance difference (i.e. difference).

### BRIEF DESCRIPTION OF DRAWINGS

FIG. 1 are one and another conceptual views schematically showing a correction concept of correcting a relative output feature, including a delay amount and a correction coefficient of an output level, in two speakers that are not disposed at equal distances on the basis of an audience, in an embodiment (FIG. 1(a) and FIG. 1(b)).

FIG. 2 is a block diagram showing the basic structure of a speaker output correcting apparatus, which corrects the relative output feature, including the delay amount and the correction coefficient of the output level, in the two speakers that are not disposed at equal distances on the basis of the audience, in the embodiment.

FIG. 3 is a graph showing one example of an amplitude feature of the signal feature of a first test signal and a second test signal, which are outputted in a correction process of correcting the relative output feature, in the two speakers that are not disposed at equal distances on the basis of the audience, in the embodiment.

FIG. 4 is a flowchart showing a flow of an entire operation in the correction process of correcting the outputs of audio signals, in the two speakers that are not disposed at equal distances on the basis of the audience, in the embodiment.

FIG. 5 are a graph conceptually showing a change in the power feature of the first test signal and the second test signal, which are sound-collected (FIG. 5(a)), and a graph schematically showing the power feature in which such a frequency is generated that the level of the square sum of an amplitude is relatively low in a case where a phase difference is generated between the first test signal and the second test signal (FIG. 5(b)), in the embodiment.

FIG. 6 is a flowchart showing a flow of a process of calculating a difference which is to determine the delay amount on speakers SP1 and SP2, in the embodiment.

FIG. 7 is a schematic diagram conceptually showing a process of storing and extracting a synthesized signal in which the first test signal and the second test signal are actually synthesized, in the embodiment.

FIG. 8 is a schematic diagram in which Fourier transform based on moving average and Fourier transform based on a Humming window are conceptually compared, in the embodiment.

### DESCRIPTION OF REFERENCE CODES

SP1 first speaker
SP2 second speaker
10 speaker output correcting apparatus
11 signal source
13 delay device
14 output level correction device
12 correction device
15 analysis device
16 sound source
17 memory device
AMP1 (amplifiers AMP0, AMP2) amplifier
DAC1 (DAC2) D/A converter (Digital to Analog converter)
MIC sound correcting device such as a microphone
ADC A/D converter (Analog to Digital converter)
CPU Central Processing Unit

### BEST MODE FOR CARRYING OUT THE INVENTION

Hereinafter, the best mode for carrying out the present invention will be explained in each embodiment in order on the basis of the drawings.

(1) Concept of Correcting an Output Feature Corresponding to a Distance Difference between Two Speakers

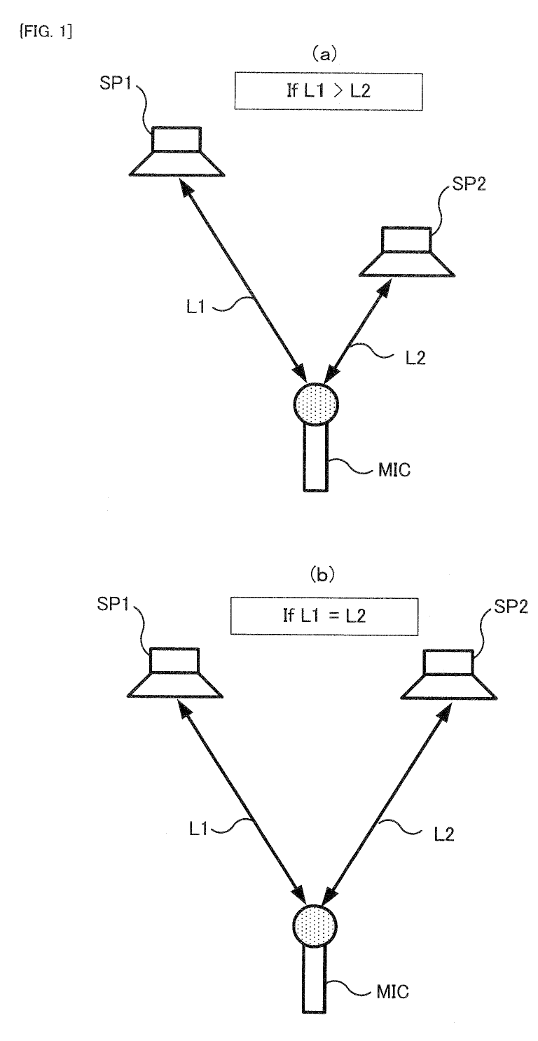

Firstly, with reference to FIG. 1, an explanation will be given on a correction concept of correcting a relative output feature, including a delay amount and a correction coefficient of a output level, in two speakers that are not disposed at equal distances on the basis of an audience, in an embodiment.

As shown in FIG. 1(a), if the two speakers SP1 and SP2 are not disposed at equal distances on the basis of the position of a sound-collecting device such as a microphone, disposed near an audience, the outputs of audio signals from the two speakers are corrected as shown in FIG. 1(b) as if the two speakers SP1 and SP2 were disposed at equal distances on the basis of the position of the sound-collecting device such as a microphone, disposed near the audience. Specifically, the test signals are outputted from the speaker SP1 and the speaker SP2 and are sound-collected by the sound-collecting device, and the sound-collected signals are analyzed. Then, the relative output feature such as the delay amount and the correction coefficient of the output level, corresponding to a difference between (i) a first distance “L1”, which is a distance between the speaker SP1 and the sound-collecting device, and (ii) a second distance “L2”, which is a distance between the speaker SP2 and the sound-collecting device, are determined as a result of the analysis of the sound-collected signals. On the basis of the determined output feature, each of the outputs of the speakers SP1 and SP2 is corrected, which allows a normal sound source such as a CD to be reproduced as if the two speakers SP1 and SP2 were disposed at equal distances on the basis of the position of the audience.

(2) Correcting Apparatus for Correcting a Distance Difference between Two Speakers

### (2-1) Basic Structure

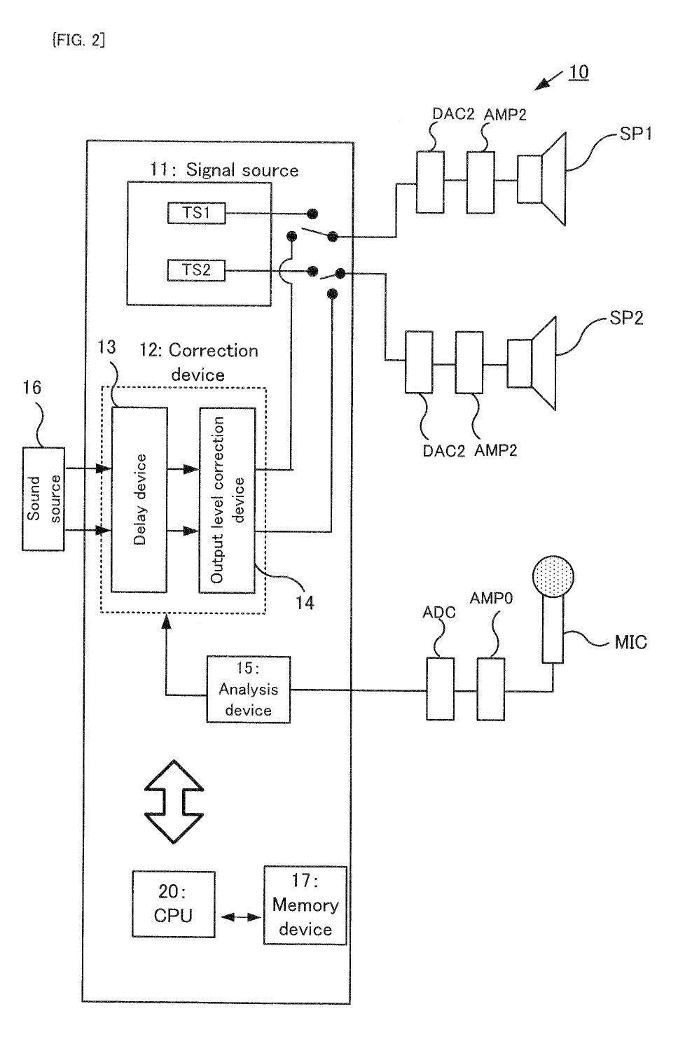

Next, with reference to FIG. 2, an explanation will be given on the basic structure of a speaker output correcting apparatus, which corrects the relative output feature, including the delay amount and the correction coefficient of the output level, in the two speakers that are not disposed at equal distances on the basis of the audience, in the embodiment.

As shown in FIG. 2, a speaker output correcting apparatus 10 in the embodiment is provided with the speaker SP1; an amplifier AMP1; a D/A converter (Digital to Analog converter) DAC1; the speaker SP2; an amplifier AMP2; a D/A converter DAC2; a signal source 11; a correction device 12 including a delay device 13 and an output level correction device 14; an analysis device 15; a sound-collecting device MIC such as a microphone; an amplifier AMP0; an AID converter (Analog to Digital converter) ADC; a normal sound source 16 such as a CD; a CPU (Central Processing Unit) 20; and a memory device 17.

The speaker SP1 is one example of the first speaker of the present invention, and the speaker SP1 outputs a first audio signal including a first test signal TS1. The speaker SP2 is one example of the second speaker of the present invention, and the speaker SP2 outputs a second audio signal including a second test signal TS2. The signal source 11 includes a signal source for the first test signal TS1 and a signal source for the second test signal TS2.

The correction device 12 is one example of the correcting device. The correction device 12 delays a signal by the delay amount with the delay device 13, and corrects the output level of the signal on the basis of the correction coefficient with the output level correcting device 14.

The analysis device 15 is one example of the calculating device of the present invention. The analysis device 15 performs a process of calculating a difference which is to determine the delay amount, and a process of determining the correction coefficient of the output level, described later, on the basis of the analysis of the spectrum of the signal.

The CPU 20 is one example of the controlling device of the present invention. The CPU 20 integrated-controls the speaker output correcting device 10, together with the memory device 17 or the like.

Briefly speaking, the first test signal TS1 on the speaker SP1 and the second test signal TS2 on the speaker SP2 are outputted simultaneously in terms of time under the control of the CPU. The signals sound-collected by the sound-collecting device are sent to and analyzed by the analysis device 15. As a result of the analysis, the relative output feature such as the delay amount and the correction coefficient of the output level is determined. On the basis of the determined output feature, each of the outputs of the speakers SP1 and SP2 is corrected by the correction device. Then, the normal sound source such as a CD is reproduced, and the audio signal is outputted.

### (2-2) Signal Feature of the First Test Signal and the Second Test Signal

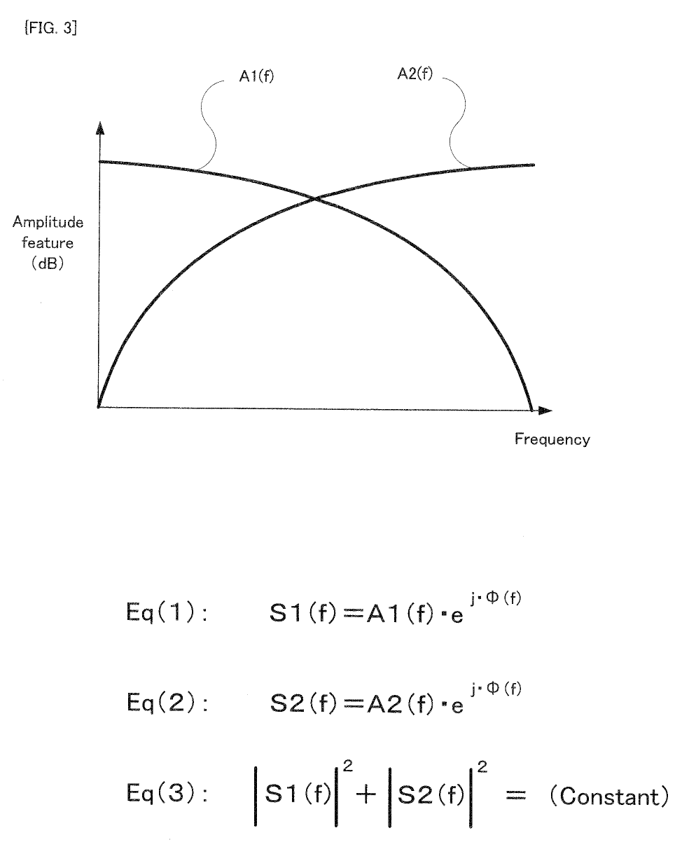

Next, with reference to FIG. 3, an explanation will be given on the signal feature of the first test signal and the second test signal, which are outputted in the correction process of correcting the relative output feature, including the delay amount and the correction coefficient of the output level, in the two speakers that are not disposed at equal distances on the basis of the audience, in the embodiment. FIG. 3 is a graph showing one example of an amplitude feature of the signal feature. Incidentally, the horizontal axis of the graph in FIG. 3 shows dB i.e., decibel.

The signal feature of the first test signal and the second test signal satisfies the following two conditions, and the first test signal and the second test signal have a cross-correlation in the signal feature. That is, the first condition in the signal feature is that phases corresponding to frequencies in the first test signal and the second test signal are equal. Specifically, as shown in the equations (1) and (2) in FIG. 3, the signal feature “S1(f)” of the first test signal can be expressed by the following equation (1) on the basis of the amplitude feature shown in FIG. 3. In addition, the signal feature “S2(f)” of the second test signal can be expressed by the following equation (2).

S1(f)=A1(f)·exp(jΦ(f)) (1)

S2(f)=A2(f)·exp(jΦ(f)) (2)

wherein, “f” denotes frequency, “exp(x)” denotes a function which expresses a value of the base of natural logarithm raised to the “xth” power, “Φ(f)” denotes a predetermined function in which frequency is a variable, and each of “A1”, “A2”, and “j” denotes a predetermined coefficient.

In addition, the second condition in the signal feature is that a power feature in the first test signal and the second test signal is designed to be constant. In other words, as shown in the following equation (3), it is constructed such that the square sum of an amplitude of a synthesized signal obtained by synthesizing the first test signal and the second test signal at each frequency (in other words, without any process added, i.e. simply) has a substantially constant value (or refer to the equation (3) in FIG. 3).

sqr{S1(f)}+sqr{S2(f)}=(constant value) (3)

wherein, “sqr(x)” is a function which expresses the square of a variable “x”.

Specifically, the frequencies of the first test signal and the second test signal may be included in a frequency band determined in accordance with the accuracy of the delay amount, which can be achieved on the correction device. For example, if a test signal with a frequency band of “500 (Hz)” to “4 k (Hz)” is used, it is possible to perform a delay correction corresponding to a difference of 4.25 (cm) to 34 (cm), for example. Alternatively, the frequencies of the first test signal and the second test signal may be included in a frequency band determined to be lower as the delay amount increases. Alternatively, the frequency band in the first test signal and the second test signal may be designed to be different from the frequency band of a noise sound in the external world and may be easily identifiable. Consequently, it is possible to perform the output correction of the speaker, more appropriately and highly accurately, on the basis of the frequencies of the first test signal and the second test signal.

### (3) Operation Principle

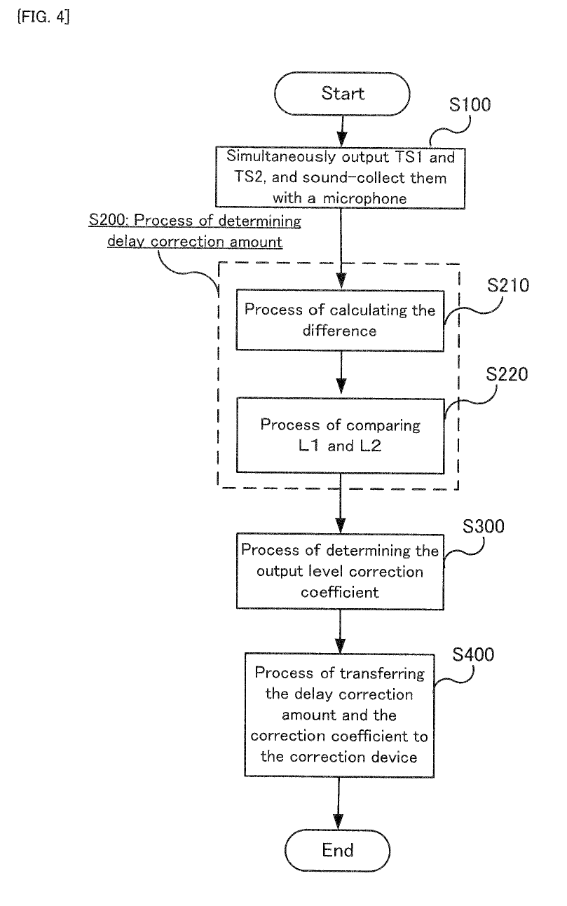

Next, with reference to FIG. 4 to FIG. 8, an explanation will be given on the operation principle of the correction process of correcting the relative output feature, including the delay amount and the correction coefficient of the output level, in the two speakers that are not disposed at equal distances, on the basis of the audience in the embodiment.

### (3-1) Entire Operation Principle

Firstly, with reference to FIG. 4, an explanation will be given on a flow of an entire operation in the correction process of correcting the relative output feature, including the delay amount and the correction coefficient of the output level, in the two speakers that are not disposed at equal distances, on the basis of the audience in the embodiment.

As shown in FIG. 4, firstly, the first test signal TS1 on the speaker SP1, which is one example of the first speaker of the present invention, and the second test signal TS2 on the speaker SP2, which is one example of the second speaker of the present invention, are outputted simultaneously in terms of time, under the control of the CPU. At the same time, the outputted first test signal and second test signal are sound-collected by the sound-collecting device MIC, such as a microphone, for example, disposed near the audience, under the control of the CPU (step S100).

Then, a process of determining the delay amount on the speakers SP1 and SP2 is performed, under the control of the CPU (step S200). The determination process is provided with a process of calculating the difference which is to determine the delay amount on the speakers SP1 and SP2 (step S210); and a process of comparing the first distance and the second distance, which is for determining the speaker to which the delay amount is applied (step S220), which will be detailed later.

Then, the correction coefficient of the output level corresponding to the difference between (i) the first distance, which is a distance between the speaker SP1 and the sound-collecting device, and (ii) the second distance, which is a distance between the speaker SP2 and the sound-collecting device, is determined as detailed later, under the control of the CPU (step S300).

Then, a transfer process of transferring information about the delay amount and the correction coefficient of the output level to the correction device 12, is performed as detailed later, under the control of the CPU (step S400).

(3-2) Principle of Calculating the Difference which is to Determine the Delay Amount

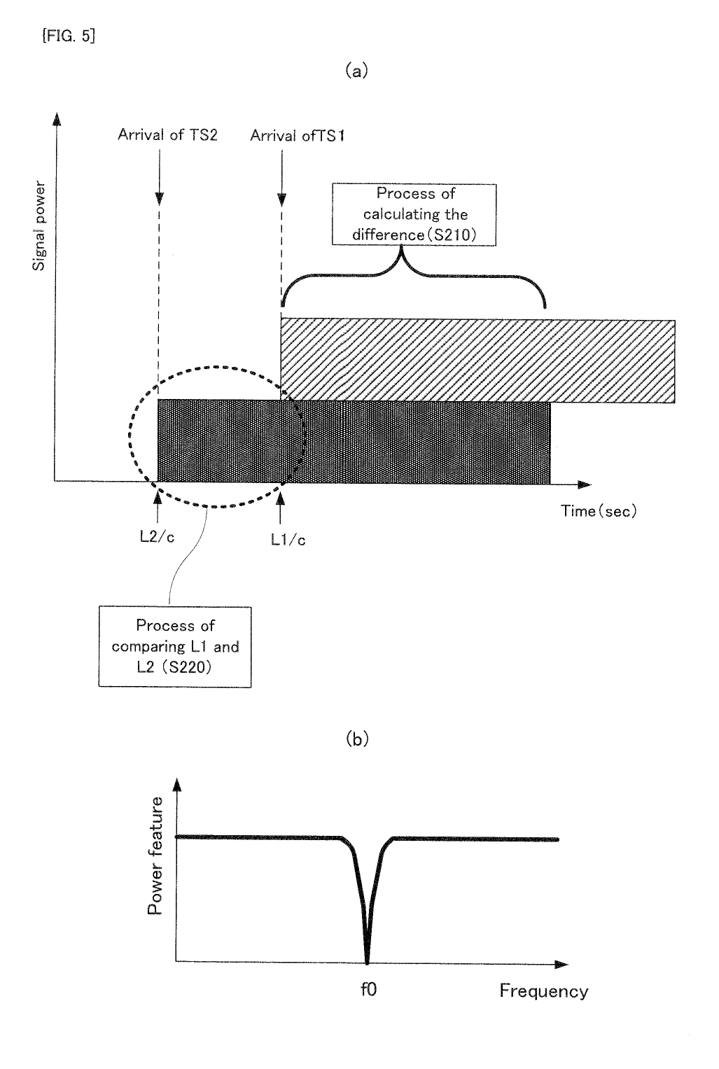

Next, with reference to FIG. 5, an explanation will be given on a principle of calculating the difference which is to determine the delay amount on the speakers SP1 and SP2, in the embodiment. FIG. 5 are a graph conceptually showing a change in the power feature of the first test signal and the second test signal, which are sound-collected (FIG. 5(a)), and a graph schematically showing the power feature in which such a frequency is generated that the level of the square sum of an amplitude is relatively low, in a case where a phase difference is generated between the first test signal and the second test signal (FIG. 5(b)), in the embodiment. Incidentally, the horizontal axis in FIG. 5 (a) shows a time axis after a time point at which the first test signal and the second test signal are sound-collected by the sound-collecting device, and the vertical axis shows the level of the square sum of the amplitude in the power feature. Moreover, FIG. 5(a) explains the case where the second distance “L2” between the speaker SP2, which is one example of the second speaker of the present invention, and the sound-collecting device disposed near the audience, is less than the first distance “L1” between the speaker SP1, which is one example of the first speaker of the present invention, and the sound-collecting device; namely, the case where the speaker SP2 is relatively closer to the sound-collecting device than the speaker SP1, as shown in FIG. 1(a) described above.

In particular, as shown in FIG. 5(a), the process of comparing the first distance “L1” and the second distance “L2”, which is for determining the speaker to which the delay amount is applied, in the aforementioned step S220, is performed, on the basis of the spectrum of the signals sound-collected from a time point “L2/c” to a time point “L1/c”, wherein “L2/c” is a time point at which the second test signal TS2 outputted from the speaker SP2, arrives at the sound-collecting device, and “L1/c” is a time point at which the first test signal TS1 outputted from the speaker SP1, arrives at the sound-collecting device. In addition, the process of calculating the difference which is to determine the delay amount on the speakers SP1 and SP2, in the aforementioned step S210, is performed, on the basis of the spectrum of the signals sound-collected after the time point “L1/c” at which the first test signal TS1 outputted from the speaker SP1, arrives at the sound-collecting device.

In calculating the difference which is to determine the delay amount, i.e. the difference between the first distance “L1” and the second distance “L2”, the spectrum analysis is firstly performed in the synthesized signal obtained by synthesizing the first test signal and the second test signal after the time point “L1/c” at which the first test signal TS1 outputted from the speaker SP1, arrives at the sound-collecting device, under the control of the CPU.

The spectrum analysis requires the following matter as a premise: the phases in the first test signal and the second test signal are designed to be equal and the power feature in the first test signal and the second test signal is designed to be constant, as explained in FIG. 3 described above. Here, the “power feature” in the embodiment denotes a feature in the power level of the two signals, such as a sum of the square of the amplitude of the first test signal and the square of the amplitude of the second test signal. Therefore, for example, the premise is that the square sum of the amplitude of the synthesized signal obtained by synthesizing the first test signal and the second test signal at each frequency (in other words, without any process added, i.e. simply) has a substantially constant value.

Therefore, if the phase difference is generated between the first test signal and the second test signal, as shown in FIG. 5(b), there is generated a frequency or frequency band in which the level of the square sum of the amplitude is relatively low (hereinafter, a “power-lacked frequency or power-lacked frequency band”, as occasion demands), in the power feature. In particular, if the phase difference between the first test signal and the second test signal is equal to half of a predetermined wavelength, the level of the square sum of the amplitude is substantially zero in the power feature, and the magnitude of the power lack amount is maximal.

That is, as described above, the phases in the first test signal and the second test signal are designed to be equal. Thus, it can be concluded that if there is generated the frequency or frequency band in which the level of the square sum of the amplitude is relatively low (or the power-lacked frequency or the power-lacked frequency band) in the power feature, the phase difference which causes that the power feature becomes low-level, is almost or totally due to the disparity between (i) a process in which a sound corresponding to the first test signal travels in the air and (ii) a process in which a sound corresponding to the second test signal travels in the air. In other words, it can be concluded that the phase difference which causes that the power feature becomes low-level, corresponds to the difference between (i) the first distance “L1”, which is for the first test signal to arrive at the sound-colleting device from the speaker SP1, and (ii) the second distance “L2”, which is for the second test signal to arrive at the sound-colleting device from the speaker SP2.

Specifically, as shown in FIG. 5(b), the phase difference calculated on the basis of a frequency “f0” at which the level of the square sum of the amplitude is relatively low in the power feature (a so-called power-lacked frequency “f0”), corresponds to the difference between (i) the first distance, which is for the first test signal to arrive at the sound-colleting device from the speaker SP1, and (ii) the second distance, which is for the second test signal to arrive at the sound-colleting device from the speaker SP2. Therefore, the difference “ [symbol] d” between the first distance and the second distance is calculated by the following equation (4).

[symbol]

d=c/(f0×2). (4)

wherein, “c” denotes a sound velocity value.

(3-3) Flow of the Process of Calculating the Difference which is to Determine the Delay Amount (step S210)

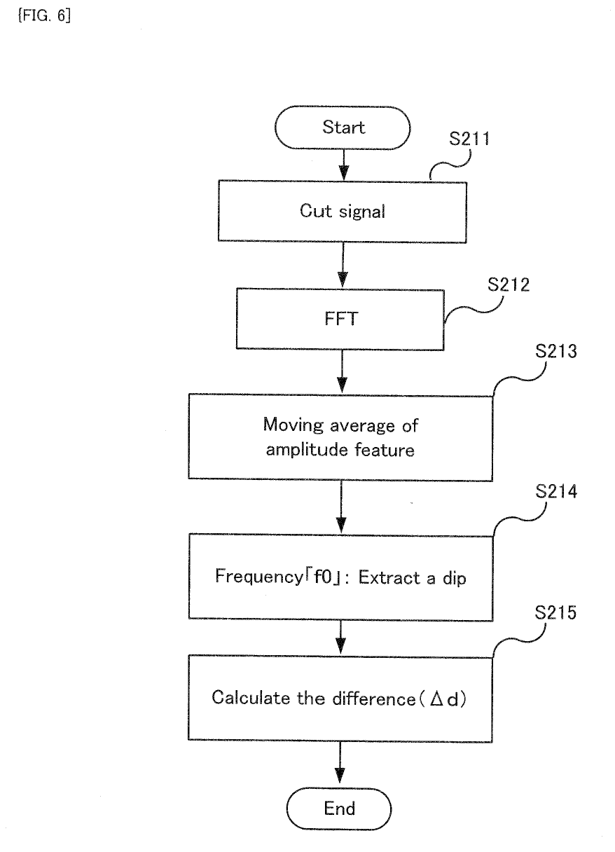

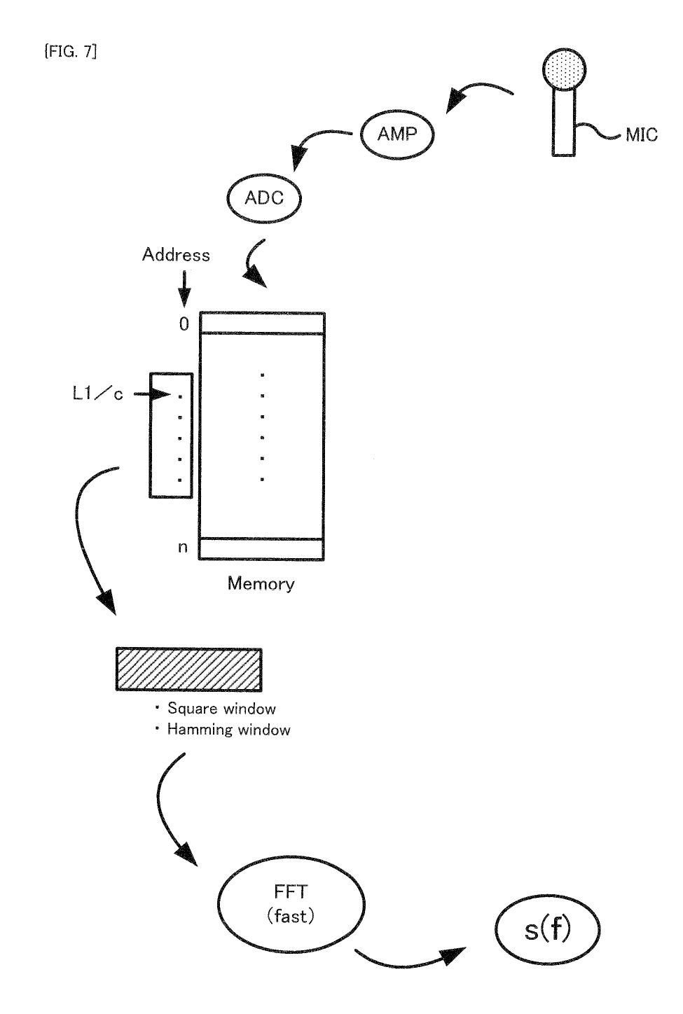

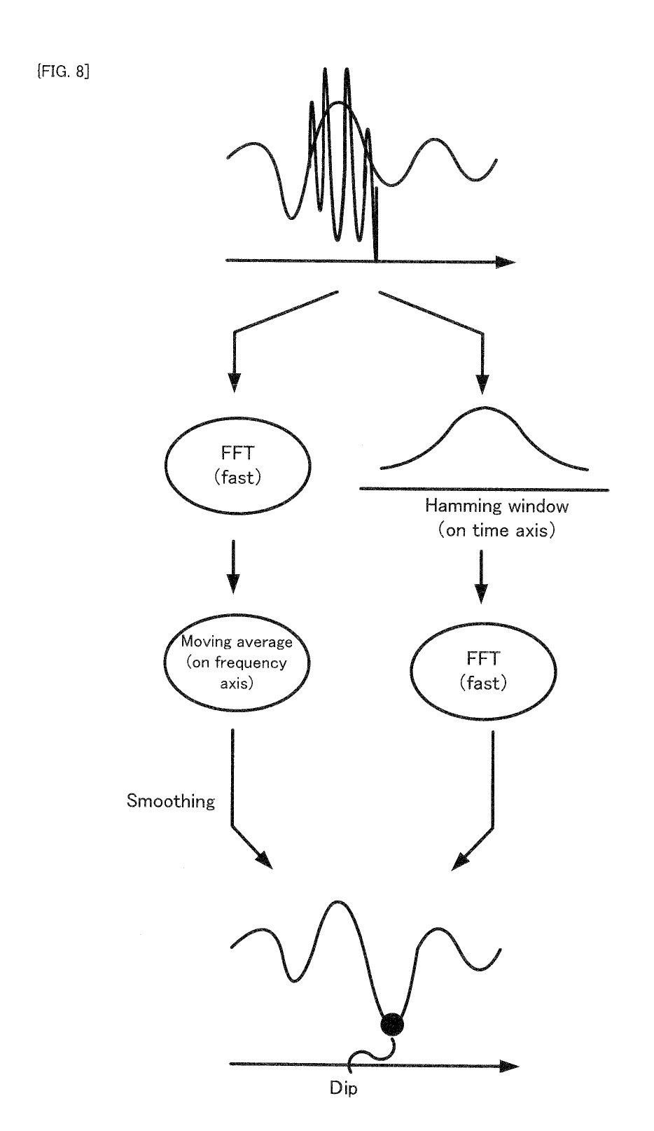

Next, with reference to FIG. 6 to FIG. 8, an explanation will be given on a flow of the process of calculating the difference which is to determine the delay amount on the speakers SP1 and SP2, in the embodiment. FIG. 6 is a flowchart showing the flow of the process of calculating the difference which is to determine the delay amount on the speakers SP1 and SP2, in the embodiment. FIG. 7 is a schematic diagram conceptually showing a process of storing and extracting a synthesized signal in which the first test signal and the second test signal are actually synthesized, in the embodiment. FIG. 8 is a schematic diagram in which Fourier transform based on moving average and Fourier transform based on a Humming window are conceptually compared, in the embodiment.

As shown in FIG. 6, in the process of calculating the difference which is to determine the delay amount on the speakers SP1 and SP2 (in the aforementioned step S210), the data of the synthesized signal is stored into the memory device 17, such as a memory, and is extracted, i.e. cut, after a time point (e.g. the time point “L1/c” in FIG. 5(a)) at which a small time elapses after the start of sound-collecting the first test signal TS1 or the second test signal TS2 with the sound-collecting device, such as a microphone, at which the first test signal and the second test signal are actually synthesized, and at which the square sum of the amplitude in the power feature becomes a constant value, under the control of the CPU (step S211). In particular, in the data of the synthesized signal, a portion sound-collected in a relatively early time after the time point (e.g. the time point “L1/c” in FIG. 5(a)) at which the square sum of the amplitude becomes the constant value is preferably stored and extracted. Therefore, it is possible to calculate the aforementioned difference, highly accurately, while reducing an influence by the external world, such as echo in an acoustic space, on the basis of the portion sound-collected in the relatively early time, of such a portion that the first test signal and the second test signal directly overlap, as a result of the spectrum analysis. Alternatively, the difference is preferably calculated on the basis of one portion immediately after such another portion that the first test signal and the second test signal overlap arrives at the sound-collecting device. Therefore, it is possible to calculate the aforementioned difference, highly accurately, with little or no influence by the external world such as echo in an acoustic space, on the basis of the portion immediately after such said another portion that the first test signal and the second test signal overlap arrives at the sound-collecting device as a result of the spectrum analysis.

Specifically, as shown in FIG. 7, the data of the synthesized signal obtained by synthesizing the first test signal and the second test signal, is stored at an address “0” to an address “n” in the memory device 17 such as a memory, and for example, the data of the synthesized signal after an address corresponding to the time point “L1/c”, can be extracted. Incidentally, FIG. 7 conceptually shows a process of amplifying the data of the synthesized signal sound-collected by the sound-collecting device MIC such as a microphone, with an amplifier, and a process of performing ADC (Analog to Digital Conversion), which is a pre-process before the storage in the memory device 17. In addition, FIG. 7 also describes a process of calculating a Fourier transform spectrum “s(f)” on the basis of fast Fourier transform to which a square window and a Hamming window are applied, described later, which is a post-process after the storage in the memory device 17.

Then, the fast Fourier transform (FFT) is performed by the analysis device 15 on the synthesized signal obtained by actually synthesizing the first test signal and the second test signal, under the control of the CPU (step S212). Specifically, instead of the fast Fourier transform, Fourier transform in an analog process may be performed, or Fourier transform in a digital process may be performed.

Then, smoothing based on moving average, is performed at each frequency (i.e. on the frequency axis) on the level of the square sum of the amplitude in the power feature, under the control of the CPU (step S213). Specifically, as shown in FIG. 8, after the fast Fourier transform is performed, the moving average and the smoothing may be performed on the frequency axis. Alternatively, after a Hamming window is applied on the time axis, the fast Fourier transform may be performed.

Then, of a frequency band corresponding to the settable delay amount (e.g. a frequency band of 200 (Hz) to 4 k (Hz)), the frequency “f0” (i.e. the power-lacked frequency “f0”) at which the level of the square sum of the amplitude is relatively low in the power feature, is detected under the control of the CPU (step S214). Incidentally, FIG. 8 shows a dip (valley) in which the level of the square sum of the amplitude is relatively low as a result of the smoothing. The phase difference calculated on the basis of the detected frequency “f0” corresponds to the difference between (i) the first distance, which is for the first test signal to arrive at the sound-colleting device from the speaker SP1, and (ii) the second distance, which is for the second test signal to arrive at the sound-colleting device from the speaker SP2. Specifically, the difference “ [symbol] d” between the first distance and the second distance is calculated by the aforementioned equation (4).

[symbol]

d=c/(f0×2) (4)

wherein, “c” denotes a sound velocity value.

Then, storing is performed by the memory device 17 such as a memory under the control of the CPU (step S215). Specifically, it can be estimated (i) that the difference “ [symbol] d” corresponds to about “34 (cm)” when the frequency “f0” is for example “500 (Hz)” or (ii) that the difference “ [symbol] d” corresponds to about “8.5 (cm)” when the frequency “f0” is for example “2 k (Hz)”.

(3-4) Process of Comparing the First Distance and the Second Distance, which is for Determining the Speaker to which the Delay Amount is Applied (Step S220)

Next, with reference to FIG. 4 and FIG. 5 described above, an explanation will be given on a flow of the process of comparing the first distance and the second distance, which is for determining the speaker to which the delay amount is applied, in the embodiment.

As shown in FIG. 4 described above, in the process of comparing the first distance and the second distance, which is for determining the speaker to which the delay amount is applied, in the embodiment (the aforementioned step S220), either the first test signal or the second test signal is stored, i.e. cut, into the memory device 17 such as a memory, in a predetermined time from a time point (refer to the time point “L2/c” in FIG. 5(a)) at which either the first test signal or the second test signal, sound-collected by the sound-collecting device such as a microphone, arrives at the sound-collecting device, under the control of the CPU (the step S220). The predetermined time is a value “ [symbol] d/c”, which is obtained by dividing the aforementioned difference by the sound velocity.

Therefore, under the control of the CPU, the spectrum of the stored (or cut) signal is calculated, and it is analyzed whether the spectrum of the stored signal is closely related to the spectrum of either the first test signal or the second test signal, shown in FIG. 3. The speaker that outputs the test signal corresponding to the spectrum which is analyzed to be closely related, can be determined to be the speaker (i) which has a relatively small distance from the sound-collecting device and (ii) which is disposed at a relatively close position to the sound-collecting device. As a result, if it is determined that the speaker SP2 is disposed at the relatively close position, it is preferable to delay the output of the sound on the speaker SP2 by a time corresponding to the predetermined time “ [symbol] d/c”, i.e. by the delay amount. On the other hand, if it is determined that the speaker SP1 is disposed at the relatively close position, it is preferable to delay the output of the sound on the speaker SP1 by the time corresponding to the predetermined time “ [symbol] d/c”, i.e. by the delay amount.

### (3-5) Process of Determining the Correction Coefficient of the Output Level, and the Like (Step S300 and Step S400)

Next, with reference to FIG. 4 described above, an explanation will be given on a flow after the process of determining the correction coefficient of the output level.

Then, the correction coefficient of the output level corresponding to the difference between (i) the first distance, which is a distance between the speaker SP1 and the sound-collecting device, and (ii) the second distance, which is a distance between the speaker SP2 and the sound-collecting device, is determined, under the control of the CPU (the step S300). For example, if it is determined that the speaker SP2 is disposed at the relatively close position, i.e. if it is determined that the second distance “L2” is less than the first distance “L1”, a correction coefficient “L2/L1” is preferably integrated with respect to the output level of the speaker SP2, because a sound theoretically attenuates in inverse proportion to a travel distance. Specifically, the second distance “L2” can be calculated on the basis of the time point at which the second test signal sound-collected by the sound-collecting device arrives at the sound-collecting device, i.e. the time point at which a value for indicating the power feature of the signal is detected, under the control of the CPU. Then, the first distance “L1” can be calculated on the basis of the calculated second distance “L2” and the abovementioned difference “ [symbol] d” between the first distance and the second distance, under the control of the CPU.

On the other hand, if it is determined that the speaker SP1 is disposed at the relatively close position, i.e. if it is determined that the first distance “L1” is less than the second distance “L2”, a correction coefficient “L1/L2” is preferably integrated with respect to the output level of the speaker SP1 on the basis of the sound theoretical attenuation as described above.

Then, the information about the delay amount and the correction coefficient of the output level is transferred to the correction device 12, under the control of the CPU (the step S400).

As a result, under the control of the CPU, it is possible to simply and quickly calculate the delay amount and the correction coefficient of the output level, which are to correct the outputs of the audio signals on the two speakers that are not disposed at equal distances on the basis of the audience, in the embodiment. Therefore, it is possible to appropriately reproduce the normal sound source, on the basis of the calculated delay amount and the correction coefficient of the output level.

The aforementioned embodiments explains the output correcting apparatus for correcting the output feature of a household and on-vehicle speaker; however, the present invention can be also applied to an output correcting apparatus for correcting the output feature of a speaker in a large space, such as a shop and a concert hall for commercial use, for example.

The present invention is not limited to the aforementioned embodiments, but various changes may be made, if desired, without departing from the essence or spirit of the invention which can be read from the claims and the entire specification. An output correcting apparatus and method, and a speaker output correcting apparatus and method, all of which involve such changes, are also intended to be within the technical scope of the present invention.

### INDUSTRIAL APPLICABILITY

The output correcting apparatus and method, and the speaker output correcting apparatus and method of the present invention can be applied to an output correcting apparatus for and method of correcting the output of a speaker apparatus, which is provided with two speakers, and a speaker output correcting apparatus and method, for example.

1-15. (canceled)

16. An output correcting apparatus comprising:
a first output terminal connected to a first speaker for outputting a first test signal;
a second output terminal connected to a second speaker for outputting a second test signal which has substantially a same phase as the first test signal and in which a power feature has a constant value if the second test signal is synthesized with the first test signal;
a calculating device for calculating a difference between a first distance and a second distance, on the basis of a spectrum of a synthesized signal obtained by synthesizing the outputted first test signal and second test signal, the first distance being a distance between the first speaker and a sound-collecting device for sound-collecting the first test signal and the second test signal, the second distance being a distance between the second speaker and said sound-collecting device;
a correcting device for correcting a relative output feature in the first speaker and the second speaker; and
a controlling device for controlling said correcting device to correct the output feature on the basis of the calculated difference,
wherein said calculating device calculates the difference on the basis of (i) a frequency at which the power feature is at a minimum level, in a portion in which the first test signal and the second test signal overlap, included in the spectrum.

17. The output correcting apparatus according to claim 16, wherein said calculating device includes a determining device for determining a magnitude relation between the first distance and the second distance, on the basis of (ii) a spectrum shape in a portion in which the first test signal and the second test signal do not overlap, included in the spectrum, corresponding to the calculated difference.

18. The output correcting apparatus according to claim 17, wherein said calculating device calculates a delay amount for relatively delaying an output time in said first output terminal or said second output terminal, on the basis of the spectrum shape in the portion in which the first test signal and the second test signal do not overlap.

19. The output correcting apparatus according to claim 16, wherein said controlling device further controls said first output terminal and said second output terminal to output the first test signal and the second test signal simultaneously in terms of time.

20. The output correcting apparatus according to claim 16, wherein said correcting device corrects (ii) a delay amount for relatively delaying an output time in said first output terminal and said second output terminal and (ii) a coefficient for relatively changing an output level in said first output terminal and said second output terminal, as the output feature.

21. The output correcting apparatus according to claim 16, wherein said calculating device calculates the difference on the basis of a Fourier transform spectrum of the synthesized signal.

22. The output correcting apparatus according to claim 16, wherein a frequency band in the first test signal and the second test signal is determined, in accordance with an accuracy of a delay amount for relatively delaying an output time in said first output terminal and said second output terminal, on said correcting device.

23. The output correcting apparatus according to claim 16, wherein a frequency band in the first test signal and the second test signal is defined to be low, if a delay amount for relatively delaying an output time in said first output terminal and said second output terminal increases.

24. The output correcting apparatus according to claim 16, wherein a frequency band in the first test signal and the second test signal is different from a frequency band of a noise sound in an external world.

25. The output correcting apparatus according to claim 16, wherein said calculating device calculates the difference, on the basis of a portion sound-collected in a relatively early time, of a portion in which the first test signal and the second test signal overlap, included in the spectrum.

26. The output correcting apparatus according to claim 16, wherein said calculating device calculates the difference, on the basis of a portion immediately, after a portion in which the first test signal and the second test signal overlap, arrives at said sound-collecting device, included in the spectrum.

27. A speaker output correcting apparatus comprising:
a first speaker for outputting a first audio signal including a first test signal;
a second speaker for outputting a second audio signal including a second test signal which has substantially a same phase as the first test signal and in which a power feature has a constant value if the second test signal is synthesized with the first test signal;
a sound-collecting device for sound-collecting the outputted first test signal and second test signal;
a calculating device for calculating a difference between a first distance and a second distance, on the basis of a spectrum of a synthesized signal obtained by synthesizing the sound-collected first test signal and second test signal, the first distance being a distance between the first speaker and said sound-collecting device, the second distance being a distance between the second speaker and said sound-collecting device;
a correcting device for correcting a relative output feature in the first speaker and the second speaker; and
a controlling device for controlling said correcting device to correct the output feature on the basis of the calculated difference,
wherein said calculating device calculates the difference on the basis of (i) a frequency at which the power feature is at a minimum level, in a portion in which the first test signal and the second test signal overlap, included in the spectrum.

28. An output correcting method on an output correcting apparatus comprising: a first output terminal connected to a first speaker for outputting a first test signal; and a second output terminal connected to a second speaker for outputting a second test signal which has substantially a same phase as the first test signal and in which a power feature has a constant value if the second test signal is synthesized with the first test signal, said output correcting method comprising:
a calculating process of calculating a difference between a first distance and a second distance, on the basis of a spectrum of a synthesized signal obtained by synthesizing the outputted first test signal and second test signal, the first distance being a distance between the first speaker and a sound-collecting device for sound-collecting the first test signal and the second test signal, the second distance being a distance between the second speaker and said sound-collecting device;
a correcting process of correcting a relative output feature in the first speaker and the second speaker; and
a controlling process of controlling said correcting process to correct the output feature on the basis of the calculated difference,
wherein said calculating process calculates the difference on the basis of (i) a frequency at which the power feature is at a minimum level, in a portion in which the first test signal and the second test signal overlap, included in the spectrum.

29. A speaker output correcting method on a speaker output correcting apparatus comprising: a first speaker for outputting a first audio signal including a first test signal; a second speaker for outputting a second audio signal including a second test signal which has substantially a same phase as the first test signal and in which a power feature has a constant value if the second test signal is synthesized with the first test signal; and a sound-collecting device for sound-collecting the outputted first test signal and second test signal, said speaker output correcting method comprising:
a calculating process of calculating a difference between a first distance and a second distance, on the basis of a spectrum of a synthesized signal obtained by synthesizing the sound-collected first test signal and second test signal, the first distance being a distance between the first speaker and said sound-collecting device, the second distance being a distance between the second speaker and said sound-collecting device;
a correcting process of correcting a relative output feature in the first speaker and the second speaker; and
a controlling process of controlling said correcting device to correct the output feature on the basis of the calculated difference,
wherein said calculating process calculates the difference on the basis of (i) a frequency at which the power feature is at a minimum level, in a portion in which the first test signal and the second test signal overlap, included in the spectrum.
